(19) United States
(12) Patent Application Publication
(10) Pub. No.: US 2022/0376848 A1
(43) Pub. Date: Nov. 24, 2022

(54) METHOD AND APPARATUS FOR HIGH DATA RATE TRANSMISSION

(71) Applicant: Focus Universal Inc., Ontario (CA)

(72) Inventor: Desheng Wang, Diamond Bar, CA (US)

(21) Appl. No.: 17/750,181

(22) Filed: May 20, 2022

Related U.S. Application Data
(60) Provisional application No. 63/190,940, filed on May 20, 2021.

(51) Int. Cl. H04L 5/00; H04L 27/26

(52) U.S. Cl. CPC H04L 5/001; H04L 27/26025

(57) ABSTRACT

Disclosed is a system and method for transmitting more data on the same bandwidth as current wireless and wired schemes use. A method for transmitting data can use orthogonal frequency domain multiplexing by identifying a lowest frequency subcarrier in an orthogonal frequency division multiplexing bandwidth that includes 64 subcarriers. The method can include receiving the second, fourth, eighth, sixteenth, thirty-second, and sixty-fourth subcarriers using a bandpass filter and decoding the set of orthogonal functions for each of the second, fourth, eighth, sixteenth, thirty-second, and sixty-fourth subcarriers. The method can further include combining the decoded data to recover the transmitted data.

### CROSS-REFERENCE TO RELATED APPLICATIONS

The present application claims the benefit of priority to U.S. Provisional Patent Application No. 63/190,940, filed May 20, 2021, the disclosure of which is hereby incorporated by reference in its entirety. Any and all applications for which a foreign or domestic priority claim is identified in the Application Data Sheet as filed with the present application are hereby incorporated by reference under 37 CFR 1.57.

### FIELD

The present invention relates to encoding a signal in order to transmit data.

### BACKGROUND

In the state-of-the-art in wireless communications, signals are encoded by various encoding schemes. The most simple may be binary phase shift keying (BPSK). BPSK is capable of encoding one bit per cycle of whatever frequency signal is being encoded. Two positions of phase shift are used, one to indicate a binary one, and another to indicate a binary zero.

A step up from BPSK is quadrature phase shift keying (QPSK). In QPSK, one symbol per cycle is encoded. That symbol encodes two bits of information, doubling the maximum possible data rate of BPSK, Again. QPSK uses phase shift keying, or changes in the phase of individual cycles, to encode data. Each cycle is independent f om the others.

The next step up from QPSK is known as 8PSK. In this scheme, there are eight different phase positions to which the signal may be shifted. By having eight different possibilities, three bits may be encoded by each symbol. One symbol is encoded per cycle.

There are encoding schemes which may provide even more bits per symbol. Quadrature amplitude modulation (QAM) comes in several different formats, from 16 possible points to 256 possible points. 16QAM can encode four bits per symbol, 32QAM can encode five bits per symbol, 64QAM can encode six bits per symbol, 128QAM can encode seven bits per symbol, and 256QAM can encode 8 bits per symbol. Unlike pure PSK, in QAM, both the amplitude and the phase are modulated to encode the symbol.

Each of the encoding schemes may be used in a multi-frequency waveform, for example, orthogonal frequency division multiplexing (OFDM). In OFDM, a set of frequencies forming a bandwidth are each encoded with one of the above encoding schemes. The orthogonality in the OFDM is formed by choosing frequencies which, when viewed in the frequency domain any neighboring frequency is at zero when the frequency in question is at its max.

Thus, in the past, every independent variable has been used to get higher data rates. Phase shifting has been used to encode data, either amplitude alone or in combination with phase shifting has been used to encode data, and bandwidths have been used to encode more data. Primarily, these are all dependent variables. However, time has not been used to provide either additional data per cycle or to combat noise in order to lessen error correction encoding.

For the foregoing reasons, there is a need for a method and system of high data rate encoding and transmission which takes advantage of time in order to provide high data rates and robustness against noise.

### SUMMARY

In some embodiments, a method for transmitting data using orthogonal frequency domain multiplexing can include identifying a lowest frequency subcarrier in an orthogonal frequency division multiplexing bandwidth that includes 64 subcarriers. The method can include selecting the second, fourth, eighth, sixteenth, thirty-second, and sixty-fourth subcarriers in the orthogonal frequency division multiplexing bandwidth and preparing a set of orthogonal functions for each of the second, fourth, eighth, sixteenth, thirty-second, and sixty-fourth subcarriers. The method can further include encoding, using the sets of orthogonal functions, data on each cycle of the second, fourth, eighth, sixteenth, thirty-second, and sixty-fourth subcarriers with data in a transmission interval. The method can further include transmitting the second, fourth, eighth, sixteenth, thirty-second, and sixty-fourth subcarriers over a transmission interval. The method can include receiving the second, fourth, eighth, sixteenth, thirty-second, and sixty-fourth subcarriers using a bandpass filter and decoding the set of orthogonal functions for each of the second, fourth, eighth, sixteenth, thirty-second, and sixty-fourth subcarriers. The method can further include combining the decoded data to recover the transmitted data.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a visualization of the subcarriers used by an embodiment of the present disclosure;

FIG. 2 shows an example matrix of combinations of symbols; and

FIG. 3 shows a block diagram that illustrates a computer system upon which various embodiments may be implemented.

### DETAILED DESCRIPTION

The detailed description set forth below in connection with the appended drawings is intended as a description of the presently preferred embodiment of a method for encoding a signal for high data rate transmission and robustness against noise, and is not intended to represent the only form in which it can be developed or utilized. The description sets forth the functions for developing and operating the method and system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

While nearly every current encoding scheme concentrates on encoding single cycles of a frequency or even shorter burst transmission, the disclosed encoding scheme uses a combination of orthogonal functions across a single cycle of the lowest frequency in a bandwidth, and multiple cycles in selected higher frequencies to encode and then detect the encoded data. This method and system offers increased data rates compared to other encoding systems, for example, current OFDM encoding, and increased robustness against data loss due to noise and interference.

Specifically, the system and method uses a plurality of orthogonal functions encoded on the lowest, and all even subsequent subcarrier frequencies, in the bandwidth. For example, if an 802.11a wireless standard is being used, the lowest subcarrier frequency, the second lowest, the fourth lowest, sixth lowest, and so on will be encoded to carry additional data using a plurality of orthogonal functions. While the example uses the 802.11a standard, one of ordinary skill in the art will recognize that the system and method will work with any bandwidth of subcarriers, and therefore any OFDM system.

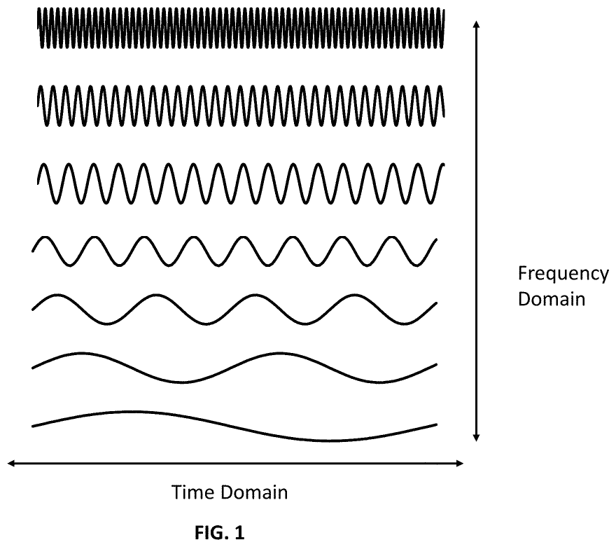

FIG. 1 illustrates a visualization of the subcarriers used by an embodiment of the present disclosure. For illustration purposes, FIG. 1 depicts the embodiment in the context of an 802.11a OFDM protocol in the frequency and time domains. Normally, the 802.11a OFDM includes 64 subcarriers of which 48 are used to carry data, four are used as pilots, and the remainder are used as null. Depending on the encoding scheme and error correction used, the data rate for an 802.11a OFDM ranges from 6 Mbps using BPSK and ½ forward error correction (FEC) to 54 Mbps using 16 QAM and ¾ FEC. Traditional 802.11a OFDM uses a burst transmission. The burst transmission is broken in to several parts. The burst includes a preamble of 16 microseconds in duration, a signal portion of one OFDM symbol of four microseconds in duration, and one or more data symbols, each of four microseconds in duration. Each subcarrier is spaced 312.5 kHz from the other subcarriers in the frequency domain.

In contrast, the embodiment of the disclosure illustrated in FIG. 1 uses only seven subcarriers. The subcarriers are chosen because each subcarrier frequency can support a plurality of signals using two or more functions, all of which are orthogonal to one another. Further, the plurality of signals at each subcarrier are orthogonal to the plurality of signals on all the other subcarriers. Thus, the six subcarriers can each carry an amount of data corresponding to the number of cycles in the transmission time. The transmission time is the time required to transmit a single cycle of the lowest frequency subcarrier. Although the lowest frequency subcarrier is not used for transmission, it is used to set the overall time of a transmission. For example, the first subcarrier, or lowest frequency subcarrier in the 20 MHz 802.11a OFDM bandwidth controls. The subcarriers which are powers of two are used as subcarriers. Thus, the six subcarriers would be the second subcarrier, the fourth subcarrier, the eighth subcarrier, the sixteenth subcarrier, the thirty-second subcarrier, and the sixty-fourth subcarrier.

Because the disclosed embodiment makes much more efficient use of the time domain for each of the subcarriers, the data rate may be greatly increased as compared to the standard 802.11a OFDM data rates. Again, the data rate increase is achieved despite dropping from 48 subcarriers to seven subcarriers. Using BPSK and ½ FEC, the disclosed embodiment the data rate for this embodiment of the disclosure is 682.5 Mbps, and using 64QAM and ¾ FEC, it is 6142.5 Mbps. In both cases, the disclosed embodiment outperforms the state of the art 802.11a OFDM by more than two orders of magnitude of the data rate while using the same bandwidth and fewer subcarriers. The burst transmission is replaced by a transmission length of one cycle of the lowest frequency in the bandwidth. This increase in data rate is solely due to more efficient use of the time domain, and specifically, the ability to encode all the cycles of the higher frequencies in the bandwidth.

Additional hardware requirements are minimal. The same bandpass filter for the 20 MHz bandwidth may be used. The same processors, transmitters, and receivers may be used. Largely, the changes may be software related.

In order to encode the data, pairs of orthogonal functions are used. Each pair of orthogonal functions may be integrated through the transmission period in order to recover the coefficients for the data. Thus, in addition to the use of some subcarriers in the OFDM scheme, the embodiment further makes use of orthogonal multiplexing of each of the seven subcarrier frequencies.

The mathematical principles behind the multiplexing of each individual frequency are discussed below.

We will start with the case of the second subcarrier frequency, as the number of functions to be mixed are fewer, and therefore more easily understood. However, one of ordinary skill in the art can extrapolate for the remainder of the frequencies. The second subcarrier frequency completes two cycles in the time the first subcarrier frequency completes one cycle. This may be understood by reviewing the frequency separation. If the first subcarrier is at 312.5 kHz, then the second subcarrier is at double that frequency, 625 kHz, or 312.4 kHz+312.5 kHz. Thus, we will be able to obtain two symbols from the second subcarrier wave. We start with four expressions:

$$F 1 ( t ) = \{ \begin{matrix}A 1 ( t ) sin ( ω t + Φ ) , & 0 < t \leq T \\ A 1 ( t ) sin ( ω t + Φ ) , & T < t \leq 2 T\end{matrix} \\ F 2 ( t ) = \{ \begin{matrix}A 2 ( t ) sin ( ω t + Φ ) , & 0 < t \leq T \\ - A 2 ( t ) sin ( ω t + Φ ) , & T < t \leq 2 T\end{matrix} \\ G 1 ( t ) = \{ \begin{matrix}A 3 ( t ) cos ( ω t + Φ ) , & 0 < t \leq T \\ A 3 ( t ) cos ( ω t + Φ ) , & T < t \leq 2 T\end{matrix} \\ G 2 ( t ) = \{ \begin{matrix}A 4 ( t ) cos ( ω t + Φ ) , & 0 < t \leq T \\ - A 4 ( t ) cos ( ω t + Φ ) , & T < t \leq 2 T\end{matrix}$$

where ω is the frequency, “t” is time, and Φ is the phase at the frequency. T is the period or cycle of the frequency. The period may be half a cycle or a full cycle. The above example defines T as a half cycle, and, thus, the coefficients are maintained throughout each period. However, when the period is defined as a full cycle, the coefficients may be varied for the second period. It is the choice of the user as to how to define the period. As discussed above, the second subcarrier has two cycles for every one of the first subcarrier, however, this has no bearing on the definition of the period, T. As shown above, the functions change from the first period to the second period. Depending on the subcarrier frequency, the functions may all be different for each of the periods or cycles, or the functions may repeat after a predetermined number of periods or cycles.

It can be shown that these functions are orthogonal at the 2T period end. As a result, these functions can be sent concurrently, encoding the coefficients A1-A4. To make the orthogonality in combination more clear, we may combine the Sine and Cosine functions, yielding:

$$Q 1 ( t ) = \{ \begin{matrix}A 1 ( t ) sin ( ω t + Φ ) + A 3 ( t ) cos ( ω t + Φ ) , & 0 < t \leq T \\ A 1 ( t ) sin ( ω t + Φ ) + A 3 ( t ) cos ( ω t + Φ ) , & T < t \leq 2 T\end{matrix} \\ Q 2 ( t ) = \{ \begin{matrix}A 2 ( t ) sin ( ω t + Φ ) + A 4 ( t ) cos ( ω t + Φ ) , & 0 < t \leq T \\ - \{ A 2 ( t ) sin ( ω t + Φ ) + A 4 ( t ) cos ( ω t + Φ ) \} , & T < t \leq 2 T\end{matrix}$$

The signals corresponding to the various sine and cosine functions may be transmitted by using either a switching system using logic gates, or may be combined before transmission and queued for transmission. For example, there may be a transmission side buffer which queues as many functions as necessary to allow the processor to stay ahead of the cyclic requirements. Because each frequency has differing cyclic requirements, and specifically, because these requirements vary exponentially from the lowest frequency subcarrier to the highest frequency subcarrier, the combined processing of all the subcarriers must be taken in to account, but one of ordinary skill in the art will recognize that the requirement will be primarily driven by the highest frequency subcarrier. Preparation of such signals are already well known in the art, as QAM modulation or encoding techniques require the preparation of such functions before transmission. The functions may be assembled serially based on a clock signal which has the same frequency as the highest frequency subcarrier.

The signal, created by combining a series of one or more functions with combined orthogonal functions of sine and cosine per cycle, is transmitted simultaneously with the other functions for that frequency. For example, if the frequency of the subcarrier has 16 cycles for every one of the lowest frequency subcarrier, then there is a set of 16 functions, or a set of 16 combined series of sine and cosine functions, similar to those shown in Q1(t) and Q2(t) above. The set is transmitted and received along with all the other sets of functions on the other frequencies. There is no need to filter beyond the bandwidth filter because each function within the set is orthogonal to all the other functions or series of functions for the transmission.

As one of ordinary skill in the art will recognize, the sets of functions described above can be both internally and externally orthogonal. For example, each set of functions for a subcarrier may be orthogonal for the number of cycles in that frequency equal in time to one cycle of the lowest frequency subcarrier. A single cycle of the lowest frequency subcarrier defines a transmission interval. For example, the sixty-fourth subcarrier may have 64 cycles for every one cycle of the first subcarrier. Further, the sets of functions are externally orthogonal as well. That is, the set of functions or series of functions on any one of the subcarriers is orthogonal to all the other sets of functions or series of functions on the other subcarrier frequencies. Thus, when integrated over the transmission interval, all of the coefficients form the functions may be recovered, thereby recovering all of the data.

The coefficients may be stored in a memory. Each pair of coefficients, for example A1 and A3, and A2 and A4 from the example above, may represent a symbol in an encoding scheme. Depending on the encoding scheme, the symbol can represent just one bit, and as many as eight bits. The limitation with encoding more information is that as the individual coefficients get closer and closer to each other, they are more difficult to distinguish between each of the symbols, especially if there is any noise or interference with the signal. For example, binary phase shift keying (BPSK) may use just two symbols. Each symbol represents a single bit, either one or zero. The first symbol may represent a first of the one or zero, and a second symbol represents the other of the one or zero. With BPSK, at least one of the coefficients will be zero, leading to ease of detectability at the cost of decreased data. Encoding schemes are increasingly more complex after the two symbol BPSK scheme. Without providing examples from every encoding scheme, all of which are well known in the art, a higher order encoding scheme is 64QAM. That is, an encoding scheme which varies amplitude and phase to encode symbols. As the name implies, 64QAM has 64 symbols, each corresponding to a unique combination of a string of ones and zeros. Because there are 64 possible combinations, 64 QAM can encode six bits per symbol.

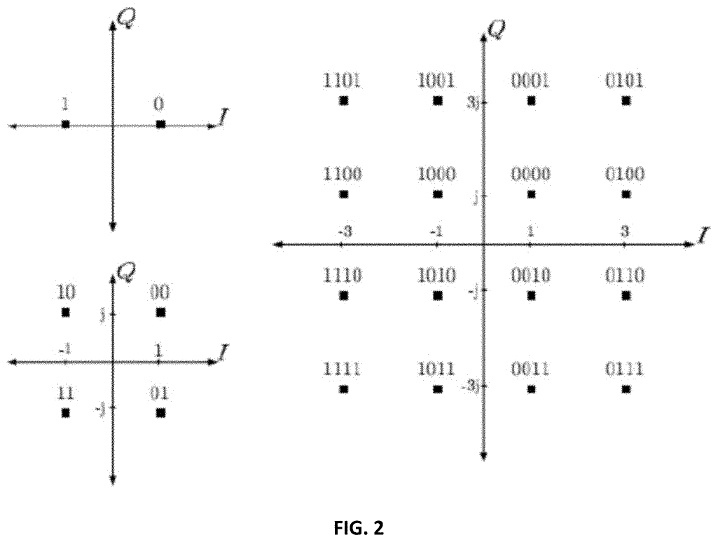

FIG. 2 shows an example matrix of combinations of symbols. In a 16×16 matrix of combinations 256 possible combinations are possible, which allows 8 bits to be encoded. Thus, 8 bits may be encoded across two cycles. Or, 4 bits/cycle. If there are two functions, 8 bits may be encoded per cycle. In a second example, meaning may be encoded in both the first and second cycles, which could be 4 bits per symbol, or eight bits for the two symbols. If the encoded point has further meaning in combination with an encoded point in the next cycle, the 8 bit encoding may be improved. 256 combinations allows 8 bits to be encoded. Thus, 8 bits may be encoded across two cycles. That is, 8 bits from the 16QAM in each Cycle, and 8 additional bits for the combination across two cycles. This could be 16 bits total for two cycles.

Some of the bits are used for forward error correction (FEC), and this will reduce the overall data rate. The amount of data used for error correction is not set. There are multiple forward error correction schemes and each is compatible with any of the encoding schemes.

Each of the functions shown in Q1 or Q2 may be encoded with any encoding scheme. BPSK may be used when lower data rates are acceptable, but higher reliability is a desired benefit. Any form of QAM may be used as well. For example, 16 QAM may be used. In the case of Q1, the coefficients of A1 and A3 would encode the 16QAM symbol. Per the 16 QAM encoding scheme, that symbol would then provide four bits of data. The coefficients may change in the time domain. That is, coefficients A1 and A3 for 0<t≤T may not be the same as A1 and A3 for T<t≤2T. This allows for encoding of a different symbol in every cycle of the subcarrier. Because every cycle of the subcarrier may be encoded, much more data may be sent during the transmission, especially on higher frequency subcarriers.

Alternatively, or in addition, other subcarriers may be used. In order to use more than the six subcarriers discussed above, a filter will be required to remove the subcarrier from the combined signal before the other six subcarriers can be decoded. However, filters are fairly low cost devices, and by using one or more of the highest frequency subcarriers in this manner, the overall data rate may be significantly improved.

For example, the sixty-third subcarrier may be used with a filter. The sixty-third subcarrier can send 63 symbols in the transmission period. An extra 63 symbols provide almost another 50% of data. Thus, by adding a single filter, the data rate changes almost 150%. Of course, additional subcarriers may be added, as long as they are independently filtered prior to the base six subcarriers being decoded. There is no need for these additional subcarriers to transmit signals which are orthogonal to one another as the sets of functions on the base six subcarriers are. Each of the separately filtered subcarriers is essentially a single carrier. However, these single carriers are arranged within the bandwidth of the OFDM scheme. For example, with the 20 MHz OFDM scheme used in the 802.11a standard, the single carriers may be chosen from among those at the upper end of the bandwidth. With the sixty-third and sixty-second subcarriers being used, the data rate may be nearly doubled.

In some embodiments, the system may include reducing the overall bandwidth by using only consecutive subcarriers at the upper end of the bandwidth. For example, one possibility may be using the sixty through sixty-fourth subcarriers. Each subcarrier would require a separate filter in order to prevent interference between the signals in decoding. However, this multi-single carrier approach would allow the highest frequencies of the bandwidth to be used while also making more efficient use of each of the cycles in the higher frequencies. Thus, data rate is also increased by using three or more of these frequencies.

Because as few as three frequencies may be used, while still obtaining a higher data rate, the overall bandwidth used may be greatly reduced. For example, the typical 20 MHz bandwidth in an 802.11a standard is divided in to 64 subcarriers spaced 312.5 kHz apart. Four of these subcarriers are used as pilots which ensure data integrity, and 48 are used to carry data, the remainder are null. Thus, some of the 64 subcarriers are not used for any data. Part of the bandwidth goes unused either to offer guard bands, or for other reasons.

Below are a number of nonlimiting example embodiments described above.

In a 1st Example, a method for transmitting data using orthogonal frequency domain multiplexing, the method comprising: identifying a lowest frequency subcarrier in an orthogonal frequency division multiplexing bandwidth comprising 64 subcarriers; selecting the second, fourth, eighth, sixteenth, thirty-second, and sixty-fourth subcarriers in the orthogonal frequency division multiplexing bandwidth; preparing a set of orthogonal functions for each of the second, fourth, eighth, sixteenth, thirty-second, and sixty-fourth subcarriers; encoding, using the sets of orthogonal functions, data on each cycle of the second, fourth, eighth, sixteenth, thirty-second, and sixty-fourth subcarriers with data in a transmission interval; transmitting the second, fourth, eighth, sixteenth, thirty-second, and sixty-fourth subcarriers over a transmission interval; receiving the second, fourth, eighth, sixteenth, thirty-second, and sixty-fourth subcarriers using a bandpass filter;

decoding the set of orthogonal functions for each of the second, fourth, eighth, sixteenth, thirty-second, and sixty-fourth subcarriers; and combining the decoded data to recover the transmitted data.

In a 2nd Example, the method of Example 1, wherein at least one additional subcarrier carries a pilot signal.

In a 3rd Example, the method of any of Examples 1-2, wherein each set of orthogonal functions is both internally orthogonal and externally orthogonal.

In a 4th Example, the method of any of Examples 1-3, wherein the transmission interval comprises, for each subcarrier frequency, a number of cycles corresponding to the interval of one cycle of the lowest frequency subcarrier.

In a 5th Example, the method of any of Examples 1-4, further comprising transmitting a guard interval.

In a 6th Example, the method of any of Examples 1-5, wherein combining the decoded data to recover the transmitted data comprises combining the decoded data from each of the second, fourth, eighth, sixteenth, thirty-second, and sixty-fourth subcarriers.

In a 7th Example, the method of Example 6, wherein combining the decoded data from each of the second, fourth, eighth, sixteenth, thirty-second, and sixty-fourth subcarriers comprises identifying common data from at least two of the second, fourth, eighth, sixteenth, thirty-second, or sixty-fourth subcarriers.

In a 8th Example, a method for transmitting data, comprising: defining a set of 64 subcarriers in order to form an orthogonal frequency division multiplexing bandwidth; identifying a lowest frequency subcarrier in the orthogonal frequency division multiplexing bandwidth, setting a transmission interval equal to one cycle of the lowest frequency subcarrier; selecting the second, fourth, eighth, sixteenth, thirty-second, and sixty-fourth subcarriers and at least one additional subcarrier in the orthogonal frequency division multiplexing bandwidth; preparing a set of orthogonal functions for each of the second, fourth, eighth, sixteenth, thirty-second, and sixty-fourth subcarriers, each set of orthogonal functions being both internally orthogonal and externally orthogonal; preparing a set of functions for the at least one additional subcarrier; encoding, using the sets of orthogonal functions, data on every cycle of the second, fourth, eighth, sixteenth, thirty-second, and sixty-fourth subcarriers in the transmission interval; encoding, using the set of functions, the at least one additional subcarrier with data on each cycle of the at least one additional subcarrier in the transmission interval; transmitting the second, fourth, eighth, sixteenth, thirty-second, sixty-fourth, and at least one additional subcarriers over a transmission interval; receiving the second, fourth, eighth, sixteenth, thirty-second, sixty-fourth, and at least one additional subcarriers using a first bandpass filter; filtering the at least one additional subcarrier using a second bandpass filter; decoding the set of orthogonal functions for each of the second, fourth, eighth, sixteenth, thirty-second, and sixty-fourth subcarriers; decoding the set of functions for the at least one additional subcarrier; and combining the decoded data to recover the transmitted data.

In a 9th Example, the method of Example 8, wherein the at least one additional subcarrier carries a pilot signal.

In a 10th Example, the method of any of Examples 8-9, wherein each set of orthogonal functions is both internally orthogonal and externally orthogonal.

In a 11th Example, the method of any of Examples 8-10, further comprising transmitting a guard interval.

In a 12th Example, the method of any of Examples 8-11, wherein combining the decoded data to recover the transmitted data comprises combining the decoded data from each of the second, fourth, eighth, sixteenth, thirty-second, and sixty-fourth subcarriers.

In a 13th Example, a system for transmitting data, comprising: a memory storing sets of orthogonal functions for each of a second, fourth, eighth, sixteenth, thirty-second, and sixty-fourth subcarriers in an orthogonal frequency division multiplexing bandwidth containing 64 subcarriers, wherein the sets of orthogonal functions are both internally and externally orthogonal; sets of coefficients stored in the memory, each set of coefficients corresponding to a symbol representing at least one bit of data; and a first processor for executing instructions on the memory, the instructions, when executed by the processor, configured to: encode, using the sets of orthogonal functions, data on each cycle of the second, fourth, eighth, sixteenth, thirty-second, and sixty-fourth subcarriers in a transmission interval; encode, using the set of functions, at least one additional subcarrier with data on each cycle of the at least one additional subcarrier in the transmission interval; and transmit the second, fourth, eighth, sixteenth, thirty-second, sixty-fourth, and the at least one additional subcarriers over a transmission interval.

In a 14th Example, the system of Example 13, further comprising: first and second bandpass filters; a second memory comprising second instructions thereon; and a second processor for executing the second instructions on the second memory, the second instructions, when executed by the second processor, configured to: receive, using the first bandpass filter, the second, fourth, eighth, sixteenth, thirty-second, sixty-fourth, and at least one additional subcarriers; and filter, using the second bandpass filter, the at least one additional subcarrier.

In a 15th Example, the system of Example 14, wherein the second instructions, when executed by the second processor, are further configured to: decode the set of orthogonal functions for each of the second, fourth, eighth, sixteenth, thirty-second, and sixty-fourth subcarriers; decode the set of functions for the at least one additional subcarrier; and combine the decoded data to recover the transmitted data.

In a 16th Example, the system of Example 15, wherein combining the decoded data to recover the transmitted data comprises combining the decoded data from each of the second, fourth, eighth, sixteenth, thirty-second, and sixty-fourth subcarriers.

In a 17th Example, the system of any of Examples 13-16, wherein combining the decoded data from each of the second, fourth, eighth, sixteenth, thirty-second, and sixty-fourth subcarriers comprises identifying common data from at least two of the second, fourth, eighth, sixteenth, thirty-second, or sixty-fourth subcarriers.

In a 18th Example, the system of any of Examples 13-17, wherein the at least one additional subcarrier carries a pilot signal.

In a 19th Example, the system of any of Examples 13-18, further comprising transmitting a guard interval.

In a 20th Example, the system of any of Examples 13-19, wherein the transmission interval is equal to one cycle of the lowest frequency subcarrier.

The above description is given by way of example, and not limitation. Given the above disclosure, one skilled in the art could devise variations that are within the scope and spirit of the invention disclosed herein, including various ways of configuring the filters and detectors. Further, the various features of the embodiments disclosed herein can be used alone, or in varying combinations with each other and are not intended to be limited to the specific combination described herein. Thus, the scope of the claims is not to be limited by the illustrated embodiments.

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

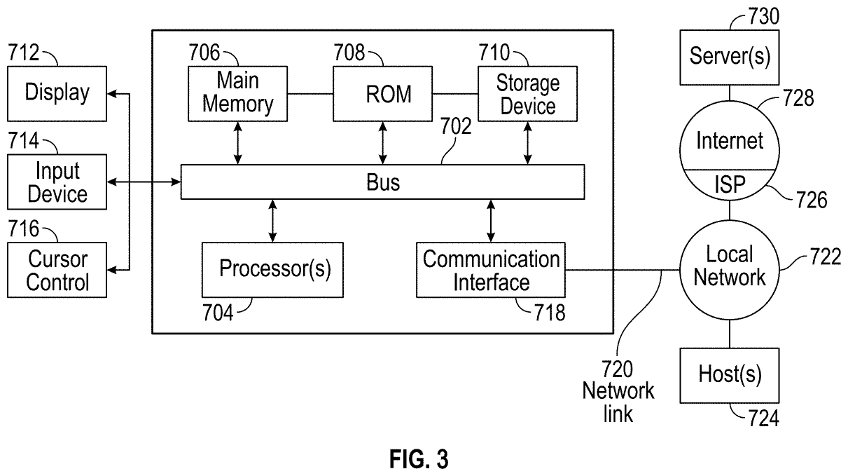

For example, FIG. 3 is a block diagram that illustrates a computer system 700 upon which various embodiments may be implemented. For example, the computer system 700 may be implemented as the graphical user interface 100 (FIG. 1) in some embodiments. Computer system 700 includes a bus 702 or other communication mechanism for communicating information, and a hardware processor, or multiple processors, 704 coupled with bus 702 for processing information. Hardware processor(s) 704 may be, for example, one or more general purpose microprocessors.

Computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

Computer system 700 may be coupled via bus 702 to a display 712, such as a cathode ray tube (CRT) or LCD display (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 700 may include a user interface module to implement a GUI that may be stored in a mass storage device as computer executable program instructions that are executed by the computing device(s). Computer system 700 may further, as described below, implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more computer readable program instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

Various forms of computer readable storage media may be involved in carrying one or more sequences of one or more computer readable program instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A method for transmitting data using orthogonal frequency domain multiplexing, the method comprising:
identifying a lowest frequency subcarrier in an orthogonal frequency division multiplexing bandwidth comprising 64 subcarriers;
selecting the second, fourth, eighth, sixteenth, thirty-second, and sixty-fourth subcarriers in the orthogonal frequency division multiplexing bandwidth;
preparing a set of orthogonal functions for each of the second, fourth, eighth, sixteenth, thirty-second, and sixty-fourth subcarriers;
encoding, using the sets of orthogonal functions, data on each cycle of the second, fourth, eighth, sixteenth, thirty-second, and sixty-fourth subcarriers with data in a transmission interval;
transmitting the second, fourth, eighth, sixteenth, thirty-second, and sixty-fourth subcarriers over a transmission interval;
receiving the second, fourth, eighth, sixteenth, thirty-second, and sixty-fourth subcarriers using a bandpass filter;
decoding the set of orthogonal functions for each of the second, fourth, eighth, sixteenth, thirty-second, and sixty-fourth subcarriers; and
combining the decoded data to recover the transmitted data.

2. The method of claim 1, wherein at least one additional subcarrier carries a pilot signal.

3. The method of claim 1, wherein each set of orthogonal functions is both internally orthogonal and externally orthogonal.

4. The method of claim 1, wherein the transmission interval comprises, for each subcarrier frequency, a number of cycles corresponding to the interval of one cycle of the lowest frequency subcarrier.

5. The method of claim 1, further comprising transmitting a guard interval.

6. The method of claim 1, wherein combining the decoded data to recover the transmitted data comprises combining the decoded data from each of the second, fourth, eighth, sixteenth, thirty-second, and sixty-fourth subcarriers.

7. The method of claim 6, wherein combining the decoded data from each of the second, fourth, eighth, sixteenth, thirty-second, and sixty-fourth subcarriers comprises identifying common data from at least two of the second, fourth, eighth, sixteenth, thirty-second, or sixty-fourth subcarriers.

8. A method for transmitting data, comprising:
defining a set of 64 subcarriers in order to form an orthogonal frequency division multiplexing bandwidth;
identifying a lowest frequency subcarrier in the orthogonal frequency division multiplexing bandwidth, setting a transmission interval equal to one cycle of the lowest frequency subcarrier;
selecting the second, fourth, eighth, sixteenth, thirty-second, and sixty-fourth subcarriers and at least one additional subcarrier in the orthogonal frequency division multiplexing bandwidth;
preparing a set of orthogonal functions for each of the second, fourth, eighth, sixteenth, thirty-second, and sixty-fourth subcarriers, each set of orthogonal functions being both internally orthogonal and externally orthogonal;
preparing a set of functions for the at least one additional subcarrier;
encoding, using the sets of orthogonal functions, data on every cycle of the second, fourth, eighth, sixteenth, thirty-second, and sixty-fourth subcarriers in the transmission interval;
encoding, using the set of functions, the at least one additional subcarrier with data on each cycle of the at least one additional subcarrier in the transmission interval;
transmitting the second, fourth, eighth, sixteenth, thirty-second, sixty-fourth, and at least one additional subcarriers over a transmission interval;
receiving the second, fourth, eighth, sixteenth, thirty-second, sixty-fourth, and at least one additional subcarriers using a first bandpass filter;
filtering the at least one additional subcarrier using a second bandpass filter;
decoding the set of orthogonal functions for each of the second, fourth, eighth, sixteenth, thirty-second, and sixty-fourth subcarriers;
decoding the set of functions for the at least one additional subcarrier; and
combining the decoded data to recover the transmitted data.

9. The method of claim 8, wherein the at least one additional subcarrier carries a pilot signal.

10. The method of claim 8, wherein each set of orthogonal functions is both internally orthogonal and externally orthogonal.

11. The method of claim 8, further comprising transmitting a guard interval.

12. The method of claim 8, wherein combining the decoded data to recover the transmitted data comprises combining the decoded data from each of the second, fourth, eighth, sixteenth, thirty-second, and sixty-fourth subcarriers.

13. A system for transmitting data, comprising:
a memory storing sets of orthogonal functions for each of a second, fourth, eighth, sixteenth, thirty-second, and sixty-fourth subcarriers in an orthogonal frequency division multiplexing bandwidth containing 64 subcarriers, wherein the sets of orthogonal functions are both internally and externally orthogonal;
sets of coefficients stored in the memory, each set of coefficients corresponding to a symbol representing at least one bit of data; and
a first processor for executing instructions on the memory, the instructions, when executed by the processor, configured to:
encode, using the sets of orthogonal functions, data on each cycle of the second, fourth, eighth, sixteenth, thirty-second, and sixty-fourth subcarriers in a transmission interval;
encode, using the set of functions, at least one additional subcarrier with data on each cycle of the at least one additional subcarrier in the transmission interval; and
transmit the second, fourth, eighth, sixteenth, thirty-second, sixty-fourth, and the at least one additional subcarriers over a transmission interval.

14. The system of claim 13, further comprising:
first and second bandpass filters;
a second memory comprising second instructions thereon; and
a second processor for executing the second instructions on the second memory, the second instructions, when executed by the second processor, configured to:
receive, using the first bandpass filter, the second, fourth, eighth, sixteenth, thirty-second, sixty-fourth, and at least one additional subcarriers; and
filter, using the second bandpass filter, the at least one additional subcarrier.

15. The system of claim 14, wherein the second instructions, when executed by the second processor, are further configured to:
decode the set of orthogonal functions for each of the second, fourth, eighth, sixteenth, thirty-second, and sixty-fourth subcarriers;
decode the set of functions for the at least one additional subcarrier; and
combine the decoded data to recover the transmitted data.

16. The system of claim 15, wherein combining the decoded data to recover the transmitted data comprises combining the decoded data from each of the second, fourth, eighth, sixteenth, thirty-second, and sixty-fourth subcarriers.

17. The system of claim 13, wherein combining the decoded data from each of the second, fourth, eighth, sixteenth, thirty-second, and sixty-fourth subcarriers comprises identifying common data from at least two of the second, fourth, eighth, sixteenth, thirty-second, or sixty-fourth subcarriers.

18. The system of claim 13, wherein the at least one additional subcarrier carries a pilot signal.

19. The system of claim 13, further comprising transmitting a guard interval.

20. The system of claim 13, wherein the transmission interval is equal to one cycle of the lowest frequency subcarrier.
